(19) United States
(12) Patent Application Publication
(10) Pub. No.: US 2014/0141286 A1
(43) Pub. Date: May 22, 2014

(54) PLEATED CATHODE ELECTRODE: HIGH SURFACE AREA, LIGHT-WEIGHT, MODIFIED PACKED-BED ELECTRODE FOR OXYGEN REDUCTION

(71) Applicant: J. Craig Venter Institute, Rockville, MD (US)

(72) Inventors: Orianna Bretschger, San Diego, CA (US); Greg Wanger, San Diego, CA (US)

(73) Assignee: J. Craig Venter Institute, Rockville, MD (US)

(21) Appl. No.: 13/968,976

(22) Filed: Aug. 16, 2013

Related U.S. Application Data
(60) Provisional application No. 61/683,922, filed on Aug. 16, 2012.

(51) Int. Cl. C02F 3/00; H01M 8/16

(52) U.S. Cl. CPC C02F 3/005; H01M 8/16
USPC 429/2

(57) ABSTRACT

Featured herein are oxygen reduction electrodes configured in an electrochemical system, such as a microbial fuel cell, comprising a cathode configured as a pleated sheet and an anode comprised of a conductive material.

### RELATED APPLICATIONS

This application claims the benefit of priority to U.S. Provisional Patent Application Ser. No. 61/683,922, filed Aug. 16, 2012; the contents of which are hereby incorporated by reference.

### BACKGROUND

The water-energy relationship has risen to the forefront of topics in California and other Southwestern states. The 2005 report issued by the California Energy Commission (CEC) entitled “California's Water-Energy Relationship” elucidates the energy costs of wastewater treatment and emphasizes the need for more efficient, less energy intensive, treatment strategies.

The CEC has estimated that the State's wastewater processes in 2001 (including delivery, treatment, and disposal) resulted in the consumption of over 2000 GWh of electricity and 2.7 trillion BTUs of natural gas [1]. As the state faces growing populations, changing environmental regulations, and limited water resources in Southern California, energy consumption for wastewater treatment is expected to rise along with energy costs [1].

This situation also extends beyond California. The United States Environmental Protection Agency (U.S. EPA) Wastewater Management Fact Sheet states that energy costs can account for 30% of the total operation and maintenance costs of wastewater treatment plants. Further, wastewater treatment plants account for approximately 3% of the electric load in the United States; and it is expected that demand for electricity from these plants will increase by nearly 20% over the next 15 years. Therefore, “Energy conservation is an issue of increasing importance to wastewater treatment plants” (USEPA 2006).

Decreasing energy consumption and promoting energy conservation during wastewater treatment can be accomplished through several strategies including: 1) implementing energy efficient equipment and practices; 2) recovery of energy during treatment processes; and 3) optimizing treatment methods to minimize overall disposal costs of wastewater effluents and biosolids.

Microbial fuel cell (MFC) systems provide a novel treatment strategy that exploit bacteria to reduce sludge volumes but with select advantages over conventional treatment technologies. For example, MFCs directly impact the energy costs required to treat and dispose of secondary biomass because these systems significantly inhibit secondary biomass growth, in addition to reducing the volumes of primary sludge, thereby decreasing the overall disposal volumes and related energy requirements. Direct electricity production is also accomplished using MFCs, which enable the bypass of energy intensive biogas purification processes and the energy inefficient burning of methane for electricity generation through conventional co-generation processes.

The catalytic activity of MFCs is generated by bacteria that attach to the conductive surfaces in the system (electrodes) and form electrochemically active biofilms. Bacteria within this biofilm enzymatically extract electrons from organic components in the sludge and transfer them to the electrode. The bacteria must perform this electron transfer to the electrode surface in order to maintain biological functions, in other words the bacteria “breathe” the electrode surface to live. MFC systems are designed to immediately move energy away from the bacteria, therefore accelerating their metabolism and increases sludge reduction rates.

Completion of the MFC reaction takes place in a physically separate, but electrically linked, compartment where different bacterial biofilms use the cathode electrode as a source for energy during the reduction of oxygen, which is provided as an oxidant. In the cathode compartment bacterial growth is limited by the energy source being delivered across the circuit and therefore biomass production is reduced relative to traditional aerobic treatment systems.

The products from a MFC system are: 1) treated non-potable water (to secondary levels) and carbon dioxide from the anode; 2) electricity as a result of the bioelectrochemical reactions in both compartments. Given the decrease in biomass production and the direct generation of electricity, MFC systems can decrease overall energy consumption and wastewater treatment costs, and provide direct benefit to rate-payers. This project addressed the feasibility and scalability of MFCs for the treatment of recalcitrant sludge, one of the most problematic and costly products resulting from conventional wastewater treatment processes.

Very few reports are available for the large-scale MFC treatment of municipal sludge. Most of the work to-date has been relative to lab-scale treatment (30-500 milliliters to) of sludge and these evaluations utilized systems that were constructed from cost-prohibitive materials, including platinum.

Research has shown that MFC systems operating with sludge as a fuel source are able to degrade between 40%-80% of the initial organic content within twelve hours of residence time (9; Scott and Murano 2007; 5; 6; Raghavulu et al. 2008). However, all of this work was conducted at a laboratory scale, using reactors holding 30 to 500 milliliters of sludge. Very little work has been conducted to scale-up these sludge reactors because many researchers use cost-prohibitive electrode materials, including platinum, as cathode catalysts to reduce oxygen to water. Other, more cost-effective, materials including stainless steel [17], cobalt oxides [18], and titanium [14] have recently been evaluated in different laboratories for catalytic and biocompatible properties.

### SUMMARY

In one aspect is featured an oxygen reduction electrode that is configured in an electrochemical system, such as a microbial fuel cell, comprising a cathode configured as a pleated sheet and an anode comprised of a conductive material. In one embodiment, the electrode additionally comprises at least one low pressure air diffuser. In certain embodiments, the low pressure air diffuser is embedded within the positive space of the pleated sheet, the negative space of the pleated sheet or both. In another embodiment, the pleated sheet is comprised of a conductive material, such as a metal (e.g. titanium, platinum or gold), a metal compound (eg. a cobalt oxide, a molybdenum oxide, a manganese oxide, a tungsten carbide cobalt, stainless steel or a combination thereof), a non-metal (e.g. graphite, graphene, a graphite-doped ceramic or a conductive polymer) or a combination thereof. In certain embodiments, the sheet is a cloth, felt, foil (e.g. a porous or solid metallic foil) or mesh (e.g. a tightly woven collection of fibers/wires or a mesh of various gap spaces and weave patterns). In certain embodiments, the sheet is a porous or solid graphene sheet. In certain embodiments, the mesh is made of a material selected from the group consisting of titanium, stainless steel or an alloy. In certain embodiments, the pleated sheet has been formed on a backing comprised of the same material. In certain embodiments the electrode is comprised of a conductive packing material within the positive spaces of the pleats. In certain embodiments, the conductive packing material is comprised of graphite granules, loose conductive fibers or rolled conductive materials. In certain embodiments, the electrode is in a tubular configuration or a flat plate configuration. In certain embodiments, the anode is comprised of graphite. In certain embodiments, the graphite is coated on a table tennis ball.

Microbial fuel cell systems, as described herein, can accelerate degradation rates relative to conventional treatment methods and potentially offer an energy neutral solution to sludge degradation, thereby decreasing overall energy consumption and wastewater treatment costs.

Further features and advantages will become apparent from the following Detailed Description and Claims.

### BRIEF DESCRIPTION OF THE DRAWINGS

FIG. 1A shows an unfilled pleated cathode.

FIG. 1B shows a top-down view of 4 different unfilled pleated-cathodes.

FIG. 1C shows filled pleated cathodes surrounding a granule packed-bed anode. The negative and filled (positive) spaces all feature air diffusers to effectively transfer oxygen across all of the active surface area sites.

### DETAILED DESCRIPTION

Featured herein is an electrode configuration that cost-effectively merges high electrical conductivity, high surface area, and efficient gas diffusion for oxygen reduction reactions (ORR). Oxygen reduction reactions are most efficiently catalyzed by noble metals; however, these metallic catalysts can be easily poisoned by residual compounds leading to decreased performance, and are expensive when considering large scale applications. Graphite has been shown to weakly catalyze ORR; however, given the low efficiencies of ORR from graphite, it is necessary to increase cathode surface area such that the cathode electrode surface is at least twice as large as the anode surface area. Increasing the surface area of a cathode structure, and associated ORR activity, is a challenge when an application demands a small reactor footprint, low cost, and light-weight materials.

To address all of these issues, a new electrode design has been developed that integrates pleated graphite fabric, granule packed-bed columns, and embedded low pressure air diffusers.

The electrode backbone is constructed with a conductive fabric or mesh that can be easily manipulated into pleated shapes. Materials can include tightly woven conductive textiles (e.g. graphite cloth or felt), porous or solid metallic foils, porous or solid graphene sheets, or tightly woven metallic meshes (e.g. 40×40 or 60×60 mesh titanium, stainless steel, or alloy screens) and/or coated substrates including subsets of any of the above. Pleats of the material are formed on top of a backing of the same material. Pleats can be arranged to have varying spacing and dimensions depending on the surface area desired. After the pleats are formed, the positive spaces can be filled with conductive packing materials such as graphite granules, loose conductive fibers, rolled conductive material, etc. Conductive woven materials and associated packing materials can be further optimized by coating or other surface enhancements.

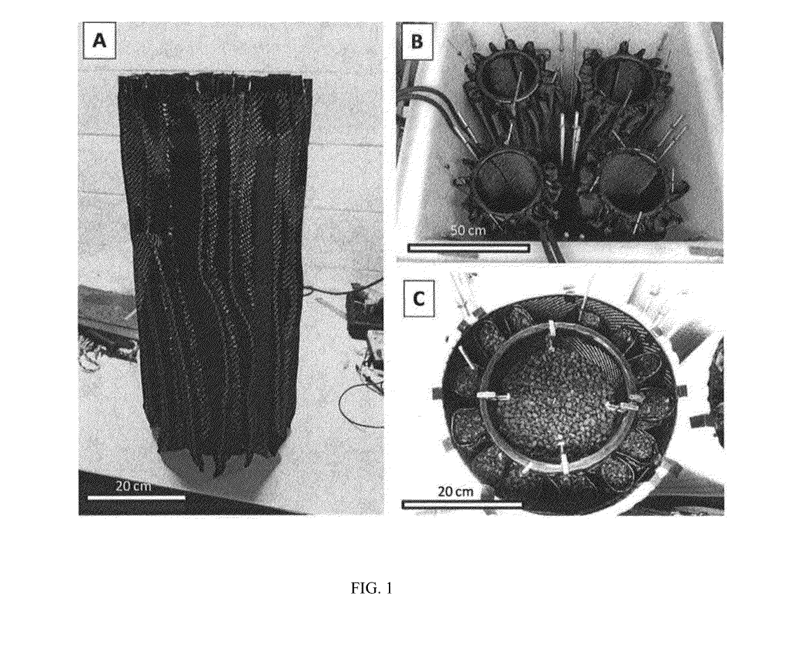

FIG. 1 illustrates an example of this electrode with 5 cm diameter pleats filled with ¼″×10 crush synthetic graphite granules. The negative and positive spaces can be used to embed air diffusers so that oxygen diffusion is maximized at the active surface.

The versatility of this electrode design is highlighted by its ease of modification to meet specific design requirements. The overall dimensions of the conductive backing and the pleats can be customized to accommodate various needs. Additionally, the fill material can be modified based on surface area, cost, and weight specifications. These electrodes could potentially be mass-produced using conventional textile sewing machines and delivered with customized packing materials.

This design dramatically reduces the weight of a given high surface area electrode assembly. There is a 5× reduction in weight when comparing to a fixed, granule packed-bed electrode of the same relative surface area. This has the benefit of being able to significantly increase the surface area without significant impact to the weight and materials cost of the overall system. Therefore, the system architectures can be easily scaled.

Once prepared, the pleated electrode can be configured into several forms that can accommodate a given electrochemical system. These include tubular and flat-plate designs in submerged liquid cathodes, air-breathing cathodes, or hydrated cathode conditions. In a tubular system (pictured in FIG. 1), the pleated structure is wrapped around the anode, decreasing the physical distance that protons must travel to be consumed in by ORR.

In the case of a flat-plate system, the pleated cathode can be configured with a rigid fabric or perforated foil backing so that distances between the anode and cathode can likewise be minimized, therefore decreasing the overall internal resistance of the system.

FIG. 1A shows an unfilled pleated cathode,

FIG. 1B shows a top-down view of 4 different unfilled pleated-cathodes.

FIG. 1C shows filled pleated cathodes surrounding a granule packed-bed anode. The negative and filled (positive) spaces all feature air diffusers to effectively transfer oxygen across all of the active surface area sites.

The invention, now being generally described, will be more readily understood by reference to the following examples, which are included merely for purposes of illustration of certain aspects and embodiments of the present invention, and are not intended to limit the invention.

### Example 1

### Microbial Fuel Cells for Sustainable Wastewater Treatment

### Project Approach

### 1) Finalize System Design for 100 Gallon Reactor.

The design of the 100 gallon system included 4 cylindrical MFC reactors, each 32″ high, with an 8″anode internal diameter, and a 14″ cathode internal diameter. The design was adapted from previous experience with MFC construction and the reported literature [2]. The reactor frames were made from drilled PVC pipe (Big Foot Manufacturing) and cast HDPE cap fittings.

The assembled reactors were specifically designed to fit inside a primary holding tank (pre-existing from another award), where it would be submerged in water. The sludge would be circulated through each MFC reactor using independent peristaltic pump tubing fixed to the end-caps of each reactor and peristaltic pumps. 100 gallons of sludge could be subsequently processed under continuous flow in one 12 hour period.

2) Determine System Modifications and Associated Costs that are Required to Accommodate Larger Volumes Based on Performance of Smaller Volume MFC Reactors.

A 20 gallon MFC reactor had previously been assembled and tested. This reactor was constructed with titanium mesh as the primary current collector and a titanium frame to prevent corrosion during long-term operation.

This system was used as a proof of concept for scalability and was subsequently used in this project to validate different electrode configurations prior to the final construction of the 100 gallon system.

The anode and cathode electrodes were both of a packed bed design. The team had previously utilized ¼″×10 crushed EC-100 synthetic graphite granules (Graphite Sales, Inc.) as the packing material at the anode and the cathode. The ¼″-crush material resulted in very little pore space in the electrode volume, which created clogging issues when sludge was introduced to the packed-bed anode.

As a first step toward determining the appropriate electrode materials for the larger 100 gallon reactor, the team modified the anode electrode configurations using ⅜″×10 crushed synthetic graphite and forming differently sized granules into stackable “pucks” with conductive graphite epoxy.

The pucks were also used as packing material and provided a conductive surface that facilitated movement electrons as well as viscous liquids. Additionally, light-weight anode packing materials were also fabricated using table tennis balls coated with a thin layer of graphite epoxy and dusted with XC-72 carbon black to enhance surface area and conductivity. The packing of these materials resulted in the “stacked-orb” anode configuration, which provides high porosity for improved fluid dynamics and high surface area and conductivity for biofilm formation and electron transfer respectively.

Subsequently, the team evaluated the materials necessary for the cathode electrode, where the oxygen reduction reaction occurs. To promote efficient reactor operation, the cathodic surface area should be significantly higher than the anodic surface area [3].

The team intended to utilize the ¼″-crush graphite materials at the cathode to enhance surface area relative to the anode; however, the mass of graphite granules needed for a 100 gallon system became cost- and weight-prohibitive. Therefore, the team developed a new “pleated” cathode electrode structure that enhances cathodic surface area, while still decreasing weight and cost through use of woven graphite cloth (US Composites, Inc.) pleated into column sections and filled with ¼″-crush granules.

3) Fabricate and Evaluate MFC Unit that Facilitates 100 Gallon Treatment Capacity.

Individual parts were ordered from the manufacturer or fabricated at the UCSD Scripps Marine Science Development Center. The research team assembled the reactor and constructed all electrode materials, separators, electrical leads, and plumbed the reactor for flow conditions. The electrodes were constructed using graphite cloth to line the interior and exterior of the frames, graphite granules to act as fine grain electrode packing material, and carbon-black coated spheres for the high-porosity stacked orb anode configuration. The anode and cathode were electronically insulated from each other by a single layer of 1 μm pore-size nylon mesh. The electrical leads embedded in the reactor compartments were strips of titanium mesh integrated with 10-24 316 stainless steel rods. Four leads were embedded in the anode and cathode compartments, respectively. Four air lines with fish tank air-stones attached were embedded in the cathode pleats to facilitate oxygen reduction at the cathode. Sixteen lines in all were utilized in the system and air was diffused through the catholyte by way of two 15 W diaphragm air pumps (Jehmco.com) attached to a gassing manifold.

Electrochemical Measurements.

The reactors were configured into two systems.

System 1 (MFCs 1 and 2) was operated under closed-circuit conditions with both MFCs operating independently with an applied load. System 2 (MFCs 3 and 4) was held at open-circuit (no current flow) after the initial inoculation to test the impact that bioelectrochemical reactions have on sludge degradation rates, relative to a packed-bed system that is not drawing current but may filter out suspended solids.

The cell voltages for both MFCs in System 1 and open-circuit anodic potentials for both MFCs in System 2 were independently monitored using voltage recording devices. The cell voltages were measured every 30 minutes across a 1000 Ohm, 10 Ohm, or 1 Ohm resistor (MFCs 1 and 2). Likewise, the anodic open-circuit potentials were measured every 30 minutes against a Ag/AgCl reference electrode. Current produced by the MFCs in System 1 was calculated using Ohm's law: Voltage=Current×Resistance (V=IR) [4].

More detailed electrochemical measurements were collected on a weekly or monthly basis. These measurements included electrochemical impedance spectroscopy (EIS), potentiodynamic polarizations of the anode and cathode electrodes, and potentiodynamic cell polarization for each MFC. All measurements were performed with a Gamry Reference 3000 potentiostat.

EIS measurements were carried for the anode and the cathode in a frequency range of 100 kHz to 5 mHz with an applied 10 mV amplitude ac signal. Anode impedance spectra were recorded using the anode as the working electrode and the cathode as the counter electrode. Cathode impedance spectra were recorded using the cathode as the working and the anode as the counter electrode. During these measurements, the Ag/AgCl reference electrode in the cathode compartment was used as the reference electrode [5].

Potentiodynamic polarizations of the electrodes were performed at a scan rate of 5 mV/sec. Anodic polarization curves were recorded for the anode, and cathodic polarization curves were recorded for the cathode. The anodic polarization curves were recorded in the potential region from −600 mV to +600 mV vs. Ag/AgCl. The cathodic polarization curves were measured at in the potential region from +600 mV to −600 mV (vs. Ag/AgCl). The starting potentials for both types of measurements varied depending on the open-circuit potentials of the anode (OCPa) or cathode (OCPc) [6].

Potentiodynamic cell polarizations were recorded at a scan rate of 2 mV/sec from the open circuit cell voltage (V0), where I=0, to the short-circuit cell voltage (Vsc=0), where I=Imax. Power (P) curves were calculated from the I-V measurements and used to determine the cell voltage (Vmax) at which the maximum power output was produced and the internal resistance (Rint) of the reactor is equal to the applied external resistance (Rext) [5].

Water Analysis.

Primary sludge samples were received from the San Elijo Joint Powers Authority Water Treatment Plant. Samples were pretreated to remove large flocks and diluted with tap water to prevent clogging issues. Full water quality analyses were performed for the pretreated sludge samples and after every 7 days exposed to reactor treatment.

Full water quality evaluations were outsourced to an EPA certified lab: TestAmerica Laboratories, Irvine. TestAmerica conducted measurements of biological oxygen demand (BOD), volatile suspended solids (VSS), total suspended solids (TSS), total nitrogen, phosphate (PO₄), sulfate (SO₄), sulfide (H₂S), turbidity, nitrate (NO₃), nitrite (NO₂) and ammonia (NH₄). A subset of water quality measurements were also performed at JCVI on a bi-weekly basis including chemical oxygen demand (COD), TSS, Turbidity, NO₃, NO₂, NH₄ and SO₄. All JCVI performed tests were conducted using Hach Company water quality kits and equipment according to the manufacturer's instructions [7-8].

Systems 1 and 2 were fed independently to evaluate treatment differences that may occur as a function of MFC or open-circuit operation. The pretreated sludge samples were stored in two 50 gallon drums and recycled through the reactor Systems once every 24 hours at a flow rate of 100 mL/min. Each System was configured such that samples flowed consecutively from the stacked-orb anode to the ⅜″-crush graphite granule anode and back into the sample drum.

Samples for water quality analysis were extracted directly from the sample drums. To prevent settling each sample drum was mechanically stirred for 10 minutes each day prior to sampling. Constant mixing was not performed to avoid aerobic sludge degradation. Each drum was exposed to the same mixing conditions except for two days out of the testing cycle when one of the stir paddles fell off of the motor. Some data variability was obvious during this time period, but subsequently normalized when the paddle was replaced.

Coulombic Efficiency.

Coulombic efficiency is an expression of how many electrons were recovered as direct electricity relative to how many are available from the degradation of BOD. The team utilized the water quality data and current versus time curves to calculate efficiency. Coulombic efficiency (CE) is calculated as Cₑₓₚ/Cₜₕₑₒᵣ, where Cₑₓₚ is the total charge accumulated for a given time period of the experiment. Cₑₓₚ is calculated as an integration of system current with respect to time and is given in units of charge (C=A*sec). Cₜₕₑₒᵣ is the theoretical charge available if all of the energy released during BOD degradation were converted directly into electricity. Cₜₕₑₒᵣ is expressed as: FnSv/M, where F is Faraday's constant (96485 C/mol of electrons), n=4 is the number of moles of electrons associated with the reduction of one mole of O₂, S is the ΔBOD for the measured time period (g/l), v is the active reactor volume (liters), and M=32 is the molecular weight of O_{2 [}9].

### 4) Develop Cost Model for Larger Scale Reactors Based on Prototype Results.

Reactor capital costs were summarized after the fabrication and assembly of the MFC reactor. Costs were expressed as $/m³ of active reactor volume and extended to estimate the cost of a 10 MGD MFC wastewater treatment plant.

Experimental treatment rates were calculated from the water analysis data and expressed as kg-BOD/m³/day. Treatment rates and reactor capital costs were evaluated and extended to annual performance (365 days) so that cost per yearly treatment is expressed as $/kg-BOD.

Power production data was used to estimate the total amount of available energy that could be recovered from a 10 MGD MFC reactor operating at full capacity. Energy production was converted to a dollar amount assuming that 1 kWhr is purchased a rate of $0.05. Capital cost was compared to annual power output to calculate $/kW. The annual dollar amount resulting from MFC power production was also compared to the total capital cost to calculate payback time assuming 4% yearly inflation and an additional $50K/yr for maintenance costs. However, maintenance costs will increase with time and the capital investment will depreciate. These considerations have not been calculated and must be considered in the next iteration of cost model development.

### 5) Develop Cost Savings Model.

The cost model developed above for a 10 MGD reactor was compared to reported capital and operational costs for treatment plants in California and savings were calculated by evaluating the differences. However, depreciation and increasing maintenance costs are not yet considered and must be addressed in future cost-savings models.

### Project Outcomes

1. Decrease Material Costs from $450,000/m³ to $20,000/m³ or Less by Investigating New Designs and Materials.

The titanium reactor that facilitated treatment for 20 gallons of primary sludge totaled a cost of $450,000/m³. To decrease this cost the team investigated the use of industrially available materials and new electrode designs. The capital cost of the 100 gallon MFC system was calculated based on materials costs of each component and the peripherals required to run the system, but excluding tax, labor and freight charges. The total material costs totaled $11,628. Based on the available pore volume (0.3 m³) in the total set of MFC reactors, the cost per volume equated to $40,494/m³. The cost breakdown per anode configuration is shown in Table 1.

TABLE 1
Materials costs per reactor component
System Material Cost Breakdown*

| Component | Cost |
|---|---|
| Pleated cathode | $414.02 |
| Seperator | $45.88 |
| Stacked Orb anode | $253.13 |
| Graphite granule anode | $364.46 |
| System frame | $1,191.17 |
| Current collectors | $296.52 |
| Stacked Orb Systems (x2) | $4,401.46 |
| Graphite Granule Systems (x2) | $4,624.11 |
| Peripherals (pumps, tubing, etc) | $2,601.90 |
| Total cost of System | $11,627.47 |

*excluding tax, freight, and labor

The final cost per volume is higher than the proposed objective; however, the research conducted under this award demonstrated that MFC reactor costs can be decreased by an order of magnitude (91% cost reduction) using alternative materials and electrode designs.
2. Demonstrate a Reduction in Total Suspended Solids from 22000 Mg/L to 6600 Mg/L in a 10 Day Period.

The raw sludge received from the San Elijo Joint Powers Authority was pretreated at JCVI, which ultimately lowered the TSS concentration from 10,000 mg/L to an initial value of 2800 mg/L. Both values are significantly lower than the stated initial TSS concentration from the objectives. However, the goal of this project was to demonstrate significant TSS removal rates (up to 70% of initial values), in a 10 day period. Table 2 shows the water quality analyses for the two reactor systems. System 1 was producing electricity and System 2 was held at open-circuit after day 22.

The team experienced some configuration issues during the first 22 days of operation, resulting in some inconsistent findings during that period. For the first 12 days, both System 1 and System 2 had one MFC reactor drawing current and one reactor held at open-circuit. From day 12 to day 22, all MFCs (1-4) were operated in a closed-circuit configuration. After day 22, Systems 1 and 2 were configured correctly with System 1 having MFCs 1 and 2 drawing a current across 1000 Ohm resistors; and System 2 was held to zero current flow, with MFCs 3 and 4 operating under open-circuit conditions. Therefore the only comparison to make between the two different system configurations occurs between day 21 and day 28 (Table 2).

TABLE 2
Water quality analysis for a single pretreated sludge sample treated for 28 days.

| | | Pre- | System 1 | | | | | | System 2 | | | | | |
|---|---|---|---|---|---|---|---|---|---|---|---|---|---|---|
| | | treated | (closed-circuit) | | | | | | (open-circuit) | | | | | |
| | Raw | Sludge | t = | t = | t = | | | | t = | t = | t = | | | |
| | Sludge | t = 0 d | 14 d* | 21 d | 28 d | %_{(14-21 day)} | %_{(21-28 day)} | %_{(0-28 day)} | 14 d* | 21 d | 28 d | %_{(14-21 day)} | %_{(21-28 day)} | %_{(0-28 day)} |
| TSS | 10000 | 2800 | 940 | 290 | 59 | 69.1 | 79.7 | 97.9 | 510 | 260 | 200 | 49.0 | 23.1 | 92.9 |
| (mg/L) | | | | | | | | | | | | | | |
| VSS | 9200 | 2700 | 890 | 260 | 53 | 70.8 | 79.6 | 98.0 | 470 | 240 | 150 | 48.9 | 37.5 | 94.4 |
| (mg/L) | | | | | | | | | | | | | | |
| BOD | 2400 | 2900 | 1700 | 1100 | 130 | 54.5 | 88.2 | 95.5 | 870 | 880 | 480 | 1.1 | 45.5 | 83.4 |
| (mg/L) | | | | | | | | | | | | | | |
| Total N | 320 | 170 | 85 | 49 | 13 | 73.5 | 73.5 | 92.4 | 63 | 49 | 32 | 22.2 | 34.7 | 81.2 |
| (mg/L) | | | | | | | | | | | | | | |
| [symbol] urbidity | 200 | 600 | 990 | 300 | 96 | 230.0 | 68.0 | 84.0 | 860 | 340 | 260 | 60.5 | 23.5 | 56.7 |
| (NTU) | | | | | | | | | | | | | | |
| NH₄ | 83 | 17 | 7 | 14 | 6.1 | 50.0 | 56.4 | 64.1 | 18 | 27 | 23 | 50.0 | 14.8 | 35.3 |
| (mg/L) | | | | | | | | | | | | | | |
| SO₄ | 30 | 20 | 26 | 37 | 52 | 29.7 | 40.5 | 180.0 | 10 | 7.6 | 2.9 | 24.0 | 61.8 | 85.5 |
| (mg/L) | | | | | | | | | | | | | | |
| HS | 4 | 12 | 1.4 | 3.2 | 2.9 | 56.3 | 9.4 | 75.8 | N/A | 3.5 | 3.1 | N/A | 11.4 | 74.2 |
| (mg/L) | | | | | | | | | | | | | | |
| NO₃ | 0 | n.d. | n.d. | n.d. | n.d. | n.d. | n.d. | n.d. | 0.68 | n.d. | n.d. | 100.0 | 100.0 | 100.0 |
| (mg/L) | | | | | | | | | | | | | | |
| NO₂ | 0 | n.d. | n.d. | n.d. | n.d. | n.d. | n.d. | n.d. | n.d. | n.d. | n.d. | n.d. | n.d. | n.d. |
| (mg/L) | | | | | | | | | | | | | | |
| PO₄ | N/A | N/A | 200 | 150 | 56 | 33.3 | 62.7 | N/A | 150 | 130 | 110 | 13.3 | 15.4 | N/A |
| mg/L) | | | | | | | | | | | | | | |

*For the first 12 days the systems were both operated at 1/2 capacity (i.e. granules were connected and stacked orbs were open circuit)
*From Day 12 to 22 both systems were operated as MFCs [symbol]
indicates data missing or illegible when filed

Additionally, the process for distribution of sludge material into the respective sample drums for systems 1 and 2 had not been optimized, resulting in lower TSS, VSS, and BOD and total nitrogen for system 2.

Accurate system activity comparisons can only be made when the initial TSS, VSS and BOD values were nearly equivalent in the two reactors, and the reactors were properly configured. This happened on day 21 of operation. Therefore, the water quality values measured on day 21 and day 28 are used for system comparison. During this seven day period the degradation rates were significantly different between the closed-circuit and open-circuit system (Table 3).

TABLE 3
Degradation rates for Systems 1 and 2 starting on day 21 of operation.
Degradation Rate (mg/L/day)

| Contaminant | System 1 | System 2 |
|---|---|---|
| TSS | 33.0 | 8.6 |
| VSS | 29.6 | 12.9 |
| BOD | 138.6 | 57.1 |

There was a 231 mg/L change in TSS for System 1 (closed-circuit, current flow) and only a 60 mg/L change for System 2 (open-circuit, no current flow) during this seven day interval, indicating that the movement of electrons away from the microbial community, i.e. current draw across the circuit, accelerated TSS removal by 74%. This is within the expectations of the proposed objective. Similar data analyses should be performed for subsequent sludge samples to verify this performance metric. Additionally, future evaluations should address TSS removal as a function of biotic and galvanic phenomena.

3. Demonstrate a Reduction in Biological Oxygen Demand from 4500 Mg/L to 2250 mg/L in a 5 Day Residence Time.

The BOD degradation rates are also shown in Table 2 and Table 3. The BOD values for the initial sludge sample were lower than the objective had proposed; however, an equivalent BOD change of 50% of the original value is a valid performance metric.

The system comparison between days 21 and 28 show that MFC operation increased BOD removal rates by 59% relative to the open-circuit system (Table 3). The BOD values changed from 1100 mg/L to 130 mg/L in System 1 (current flow), and from 880 mg/L to 480 mg/L in System 2 (no current flow), over the course of 7 days (Table 2).

4. Demonstrate Decreased Methanogenesis (Decreased Waste Gas) from 1.4 ppm to 0.7 ppm Over a 10 Day Period.

Methane concentrations were not directly measured in this reactor due to the dynamic gas exchange occurring in the reactor catholyte. Additionally, the continuous movement of fluids through the MFC reactor, and the lack of sampling ports, prevented a true internal measurement of methane production. However, DNA samples of the anode associated biomass will be collected and an analysis can be performed for the presence and abundance of mcrA genes, known to be associated with microbial methanogenesis.

Methanogenesis and electrogenesis are known to be competing reactions in microbial fuel cells [10], and reports suggest that methanogenesis is limited when a microbial community is producing current in a MFC, i.e. respiring the surface, instead of fixing CO₂.

5. Demonstrate Odor Reduction from 21 to 11 ppm H₂S Over a 5 Day Period.

Sulfide concentrations were measured during the water quality analyses (Table 2). The initial sulfide concentrations of the raw sludge were below the values listed in the objectives. During the day 21 and day 28 operational period, sulfide concentration decreased from 3.2 mg/L (ppm) to 2.9 mg/L (ppm) in System 1, and from 3.5 mg/L (ppm) to 3.1 mg/L (ppm) in System 2. These data indicate that electrogenesis does not directly compete with the microbial sulfur cycle when sludge is used as the inoculum and fuel source. However, sulfide species are highly reactive and these measurements (from the sample drums) may not accurately reflect the real-time sulfide concentrations in each reactor. Specialized sulfide-detecting electrodes have been developed to specifically study sulfide oxidation in MFCs [11]; however, these are not commercially available and so were not employed in this project.

A microbial genomic analysis can subsequently be performed on samples from the anode-associated biofilm to identify the abundance of dsrA genes, known to be involved with the microbial sulfur cycle.

6. Optimize System Operation for Sludge Reduction at Low Peak Demand (64 Mg/L/Day) and Electricity Production at High Peak Demand (1 kW/m³).

The current producing system (System 1) revealed a BOD degradation rate of 0.67 kg-BOD/m³/day while operating with a 1000 Ohm resistor applied across the external circuit. The data indicate that the two MFCs contributing to System 1 performance where producing equivalent current at day 21 of operation (10 mA/m³) and that CE for a 7 day time frame was 0.31%.

The external resistance applied to the circuits of System 1 were decreased to 10 Ohm on day 48 to evaluate the changes in degradation rates, CE, and current production if the system was operated near Imax (close to short-circuit conditions). A significant increase in activity was observed at Imax. Stable current production reached over 500 mA/m³, BOD degradation rates increased to 1.09 kg-BOD/m³/day, and CE increased to 13%.

The applied load to MFCs 1 and 2 (System 1) was dropped again to 1 Ohm after 111 days of operation. Only COD degradation was monitored during this period and it was observed that COD degradation rates were very similar between Systems 1 and 2. System 1 had a COD degradation rate of 3.53 kg-COD/m³/day and System 2 showed a degradation rate of 3.46 kg-COD/m³/day. While degradation rates increased significantly during MFC operation, this period of time (after the 1 Ohm resistors were applied) was the first observation of similar degradation rates occurring between Systems 1 and 2. This period also experienced several reference electrode failures and some volume variations and dilution issues in the recycle tanks. Therefore, it is possible that the two systems may have been short circuiting via sedimentation or fluidized particulates in the shared catholyte water.

In addition to monitoring BOD/COD degradation and current vs. time, the team also collected anodic, cathodic, and cell polarization data at regular time points throughout the 125 day evaluation period. Electrochemical impedance spectroscopy (EIS) data were also collected before inoculation and at the end of the evaluation period to determine differences in the internal resistance of the systems after operating with sludge. All polarization and EIS measurements were performed at open-circuit potentials. Prior to performing these measurements, MFCs 1 and 2 were disconnected from the applied operational load and allowed to come to an open-circuit equilibrium, as measured by stable anodic and cathodic potentials.

Power densities were calculated from cell polarization curves measured with a potentiostat (Gamry Instruments). Cell polarization curves were measured potentiodynamically by sweeping the cell voltage from the open-circuit cell voltage (V=Vₘₐₓ and I=0) to short-circuit cell voltage (V=0, and I═Iₘₐₓ) at a scan rate of 1 mV/s.

Anodic and cathodic polarization curves were performed at a scan rate of 5 mV/s in a defined potential range. The anodic scans were conducted from −600 mV to +600 mV and the cathodic scans were conducted from +600 mV to −600 mV (vs. Ag/AgCl).

Power densities from Systems 1 and 2 were calculated from cell polarization curves measured at each stage of the experiment (1000, 10 and 1 Ohm resistors applied to MFCs 1 and 2). A new sludge sample was introduced to Systems 1 and 2 each time that the applied resistors were changed across MFCs 1 and 2. This was done in an attempt to ensure that the MFCs were not limited for nutrients at the beginning of a new operational period (e.g. operating with a high load or low load).

The power densities measured during the 1000 Ohm operational period (first 31 days in operation) show that System 1 and System 2 MFCs yielded between 275 mW/m³ and 150 mW/m³ and were steadily increasing. The greatest variability among the different MFCs was observed for the open-circuit MFCs 3 and 4 (550 mW/m³ and 230 mW/m³, respectively). Power densities observed from the closed-circuit MFCs (1 and 2) were relatively consistent.

After 48 total days of operation at 1000 Ohm, MFCs 1 and 2 were connected across 10 Ohm resistors and operated at that load for the subsequent 40 days. Under these conditions, higher power densities were observed in MFCs 1 and 2 during the first day of operation at 10 Ohm.) This may be a result of a new sludge sample being introduced that day. If both System 1 and System 2 were delivering power on day 48 (day 0**, FIG. 5B), a total power density of approximately 1 W/m³ would be available for use. Interestingly, the open-circuit systems consistently showed the highest power densities over the 10 Ohm operational period, while the power densities from the closed-circuit MFCs remained relatively stable. These data indicate that charge storage still occurs at the open-circuit anodes and high power densities can be achieved if the MFCs are not continuously drawing current [12-13].

MFCs 1 and 2 were connected across 1 Ohm resistors on day 88 of the evaluation period and power production trends were observed for the subsequent 14 days. The trends from this 1 Ohm operational period remained similar to the previous data sets, with the open-circuit systems yielding higher power densities than the closed-circuit systems. MFCs 1 and 2 produced power densities between 100 and 150 mW/m³ and MFCs 3 and 4 produced power densities between 200 and 300 mW/m³, which are consistent with the power densities observed later in the 10 Ohm operational period.

Anodic and cathodic polarization curves recorded during the 1000, 10 and 1 Ohm operational periods indicate some of the limiting factors associated with performance. The trends observed in the power density data for this period correspond to the relative changes in anodic and cathodic potentials and the limiting current densities. The limiting current densities as calculated from the anodic and cathodic polarization data indicate that the MFC systems could yield up to 6.34×10³ mA/m³, which is significantly higher than the current density recorded under operation. This may be due to losses that occur during operation (e.g. due to overpotential) and these results indicate that efficiency improvements are required to achieve the maximum available current density yields from these systems. The anode and cathode open-circuit potentials (OCP) for each MFC became more electronegative after operating with sludge. However, the anodic OCPs decreased by approximately 400 mV for MFCs 1-3 and only by 250 mV for MFC 4. The highest power densities throughout the 1000 ohm operational cycle were produced by the open-circuit MFC 3, indicating higher charge storage in this system. Slowly decreasing electronegative anode OCPs were observed throughout days 17 (−195 mV vs. Ag/AgCl) and 24 (−270 mV vs. Ag/AgCl) and a very significant decrease in anode OCP by day 31 (−460 mV vs. Ag/AgCl). The limiting current density for MFC 3 was also slowly increasing in time from 3.31×10³ mA/m³ (day 17) to 6.34×10³ mA/m³ (day 31). All other MFCs also showed a trend toward more electronegative anodic OCPs; however, the values from day 17-31 remained fairly consistent in all MFCs relative to the large change observed in MFC 3. The exception was MFC 2, which showed an electropositive change in anode OCP between days 24 and 31. This behavior may be why the resulting power density from day 31 (relative to operational start) was relatively low compared to the other MFCs, even though the limiting current density was at a maximum value for the operational period (3.25×10³ mA/m³).

The anodic and cathodic polarization trends for the 10 Ohm operational period differed substantially from what was observed during the 1000 Ohm operational period.

The change in operational load across the System 1 MFCs also corresponded to a new sludge sample. Prior to the introduction of sludge, the MFCs were all flushed briefly with water. It is evident in the open-circuit system (MFCs 3 and 4) that this disruption in sludge flow caused an electropositive shift in the anode and cathode OCPs. This may also explain the relative drop in power density for MFC 3 between the operational conditions. Subsequent measurements of anodic and cathodic polarization for MFCs 3 and 4 yielded a shift toward more electronegative anode and cathode OCPs; however, limiting current densities remained relatively stable. These observed polarization trends indicate that the slight increase, and subsequent decrease and stabilization of power densities, throughout the operational period may be related to charge storage capacity at the anodes and cathodes of the open-circuit systems, as well as the oxidation rates and sludge BOD concentrations over time.

The closed-circuit systems operating with a 10 Ohm resistor across MFCs 1 and 2 maintained electronegative anodic OCPs between −400 mV and −500 mV (vs. Ag/AgCl). For both MFCs 1 and 2, the most electronegative anode OCP values were observed on the first day of the 10 Ohm operation and became slightly more electropositive over the subsequent days of operation. Unlike the open-circuit systems, MFCs 1 and 2 anodic and cathodic OCPs clustered tightly at similar values throughout the operational period. Very little relative deviation was observed, indicating that the movement of current across the circuit induces a selective pressure on the microbial community to consistently respire (move electrons to) the anode surface and maintain a charge density.

The consistent flow of electrons across the circuit also induces charge storage at the cathode. The cathodic OCPs remained close to +300 mV vs. Ag/AgCl through the operational period, which indicates that the cathodic reaction (reducing oxygen to Off, H₂O₂, or H₂O) may be limiting system performance. Cathodic OCPs higher than +600 mV vs. Ag/AgCl were only observed for MFCs 3 and 4 (open-circuit systems) after the introduction of a new sludge sample. The fact that cathodic OCPs decreased for System 2 MFCs after subsequent days of operation indicates that there were some parasitic reactions occurring at the cathode or possible short-circuits occurring in the system, which enabled charge consumption at the cathode. Possible parasitic reactions include the biotic consumption of electrons and protons stored at the cathode during the reduction of oxygen or the abiotic consumption of electrons during nitrate/nitrite or sulfate reduction.

To test the most extreme operational condition for System 1, the resistance across MFCs 1 and 2 was lowered to 1 Ohm. A new sludge sample was also introduced at the onset of this operational condition. At this point it appeared that the open-circuit MFC systems were affected by the operational conditions of MFCs 1&2. Very little variability in anodic or cathodic potentials was observed between the four systems. Additionally, the power densities remained relatively stable and all MFCs followed the same trend. This may be the result of short-circuiting between systems via fluidized particles in the shared catholyte or other parasitic reactions. These experiments should be repeated again to validate the findings. Additionally, a different system configuration with independent catholytes should be evaluated.

Electrochemical impedance spectroscopy (EIS) was also used to characterize system parameters for each MFC. EIS data were collected by a potentiostat configured to a 3-electrode system. An AC potential of 10 mV amplitude was applied to the working electrode in the frequency range of 5 mHz to 5 kHz. The results are presented as Bode plots, which show all information about impedance, frequency and phase angle for each MFC system before inoculation and after 125 days of operation with sludge. The axes of both impedance modulus (|Z|) and frequency (f) are logarithmic. The low frequency region represents the sum of the polarization resistance (or charge transfer resistance, Rₚ) of the electrode and the ohmic resistance (Rₛ) of the electrolyte. The high frequency region solely represents the ohmic resistance (Rₛ). Phase angle represents the phase shift between the applied ac signal and the measured ac response and is typically a value between 0° and −90°. A phase angle of −90° and an impedance slope of −1 is a perfect capacitor [14].

The charge transfer resistance for each MFC increased by at least 0.5 Ohms for the anodes and cathodes after the 100 day operational period. The ohmic resistances also increased slightly (between 0.2 and 0.3 Ohm) over the operational period for each MFC. The 100 day operation data were collected after MFCs 1 and 2 had been operating with a 1 Ohm resistor and likely reflect some of the parasitic reactions occurring at that time.

Additionally, the granules comprising the anode and cathode packed bed electrodes all settled after some time of saturation in water, therefore affecting the surface properties of the electrodes.

The electrochemical and COD/BOD degradation data all indicate that MFCs can compete with thermophilic anaerobic digesters for the treatment of municipal sludge.

7. Confirm that MFC Systems Will be Cost Competitive with Other Renewable Energy Technologies ($4,000-6,000 Per kW) or with Existing Electricity Generation Technologies ($1,000-2,000 per kW).

The data reported here indicate that MFC systems are not yet directly cost competitive with other renewable energy technologies. To achieve this goal, system capital costs must be decreased further and higher power densities must be recovered. Additionally, more robust cost models must be developed to calculate the real annual savings that are associated with MFC technology.

8. Confirm that Scaled MFC Systems can Provide Significant Savings ($66 Billion Annually) for the State of California by Reducing Energy Demand and Sludge Disposal Volumes During Wastewater Treatment.

The evaluated MFC system was found to remove approximately 80% of VSS and TSS, and 89% of BOD in a 7 day period, reducing the concentrations to 59 mg/L, 53 mg/L and 130 mg/L, respectively. Initial removal rates that corresponded to higher loading rates were found to be near 200 mg/L/day for VSS, TSS and BOD at mesophilic temperatures. These data suggest that mesophilic MFC removal rates are equivalent to thermophilic anaerobic digesters that require heat input to operate efficiently (assuming anaerobic sludge digesters reduce BOD values from 10,000 mg/L to 350 mg/L in a 40 day period). More analysis must be performed to confirm the savings that MFC systems could provide to California rate payers based on energy efficiencies associated with lower treatment costs and energy recovery from waste directly.

### CONCLUSIONS

1) Decrease material costs from $450,000/m³ to $20,000/m³ or less by investigating new designs and materials. The research team was able to reduce material costs down to $40,000/m³, which is a 90% cost reduction relative to other laboratory systems. This finding is encouraging and suggests further improvements to design and construction may lower costs even further.
2) Demonstrate a reduction in total suspended solids from 22000 mg/L to 6600 mg/L in a 10 day period. The research team demonstrated a 70% reduction in TSS and VSS in a 7 day period (at lower loading rates than described in the objective). Additional research is required to determine how removal rates correlate to loading rates within this system.
3) Demonstrate a reduction in biological oxygen demand from 4500 mg/L to 2250 mg/L in a 5 day residence time. The research team demonstrated an 88% reduction in BOD in a 7 day period (at lower loading rates than described in the objective). Additional research is required to determine how removal rates correlate to loading rates within this system.
4) Demonstrate decreased methanogenesis (decreased waste gas) from 1.4 ppm to 0.7 ppm over a 10 day period. The research team was not able to demonstrate a decrease in methanogenesis as a direct result of electrogenesis. More research is required to quantify these relationships and system modifications are required to collect samples appropriately for accurate analyses.
5) Demonstrate odor reduction from 21 to 11 ppm H₂S over a 5 day period. Odor reduction was observed, but not quantified. Additional monitoring equipment is required to acquire quantifiable values.
6) Optimize system operation for sludge reduction at low peak demand (64 mg L⁻¹ day⁻¹) and electricity production at high peak demand (1 kW/m³). A BOD degradation rate of 138 mg L⁻¹ day⁻¹ (0.67 kg-BOD m⁻³ day⁻¹) was calculated from the MFC system while operating with a 1000 Ohm resistor applied across the external circuit. Additional data suggest that removal rates can be increased with smaller loads applied to the circuit, i.e. operation at Imax. These data suggest that MFCs can provide efficient sludge treatment. Maximum power density was calculated throughout system operation and found to be increasing with time. The maximum power density to-date was found to be 1 W/m³. As the reactor performance improves, the performance metric of 1 kW/m³ may be realized. More evaluation is necessary to validate these findings.
7) Confirm that MFC systems will be cost competitive with other renewable energy technologies ($4,000-6,000 per kW) or with existing electricity generation technologies ($1,000-2,000 per kW). The data collected for this project indicate that MFCs are not yet cost competitive with other renewable energy technologies; however, they may be very useful for accelerating wastewater treatment costs and improving treatment energy efficiency.
8) Confirm that scaled MFC systems can provide significant savings ($66 billion annually) for the state of California by reducing energy demand and sludge disposal volumes during wastewater treatment. The data presented here do not confirm significant savings for California rate payers. Additional research is necessary to accurately determine the savings that MFC systems can provide.

### REFERENCES

1. CEC, California's Water—Energy Relationship, Final Staff Report. 2005, California Energy Commission. p. 174.
2. Rabaey, K., et al., Tubular microbial fuel cells for efficient electricity generation. Environmental Science & Technology, 2005. 39(20): p. 8077-8082.
3. Hamann, C. H., A. Hamnett, and W. Vielstich, Electrochemistry. 1998: Wiley-VCH.
4. Bretschger, O., et al., An Exploration of Current Production and Metal Oxide Reduction by Shewanella oneidensis MR-1 Wild Type and Mutants. Applied and Environmental Microbiology, 2007. 70(21): p. 7003-7012.
5. Manohar, A. K., et al., The use of Electrochemical Impedance Spectroscopy (EIS) in the Evaluation of the Electrochemical Properties of a Microbial Fuel Cell. Bioelectrochemistry, 2008. 72(2): p. 149-154.
6. Manohar, A. K., et al., The Polarization Behavior of the Anode in a Microbial Fuel Cell. Electrochimica Acta, 2008. 53(9): p. 3508-3513.
7. Diamond, J. M., et al., A performance-based framework for demonstrating appropriate use of an alternate method for wastewater compliance monitoring. Water Environment Research, 2007. 79(2): p. 208-214.
8. Fang, W. and X. Cai, Application of HACH Water Quality Analytical Instruments in Reclaimed Water Plant. China Water & Wastewater, 2010. 26(18): p. 131-133.
9. Logan, B. E., et al., Microbial Fuel Cells: Methodology and Technology. Environmental Science and Technology, 2006. 40(17): p. 5181-5192.
10. Ishii, S. i., Y. Hotta, and K. Watanabe, Methanogenesis versus Electrogenesis: Morphological and Phylogenetic Comparisons of Microbial Communites. Bioscience, Biotechnology, and Biochemistry, 2008. 72(2): p. 286-294.
11. Sun, M., et al., Microbial communities involved in electricity generation from sulfide oxidation in a microbial fuel cell. Biosensors & Bioelectronics, 2010. 26(2): p. 470-476.
12. Liang, P., et al., Alternate Charging and Discharging of Capacitor to Enhance the Electron Production of Bioelectrochemical Systems. Environmental Science & Technology, 2011. 45(15): p. 6647-6653.
13. Dewan, A., H. Beyenal, and Z. Lewandowski, Intermittent energy harvesting improves the performance of microbial fuel cells. Environmental Science & Technology, 2009. 43(12): p. 4600-4605.
14. He, Z. and F. Mansfeld, Exploring the use of electrochemical impedance spectroscopy (EIS) in microbial fuel cell studies. Energy & Environmental Science, 2009. 2(2): p. 215-219.
15. Metropolitan Wastewater Department, S. D. FY08 Metropolitan Wastewater Final Budget. 2008; Available from: http://www.sandiego.gov/mwwd/pdf/mwwdbudget.pdf.
16. Shizas, I. and D. M. Bagley, Experimental Determination of Energy Content of Unknown Organics in Municipal Wastewater Streams. Journal of Energy Engineering, 2004. 130(2): p. 45-53.
17. Zhang et al. (2011) Journal of Power Sources, 193 (3) 1097-1102.
18. Mahmoud et al. (2011) Bioresource Technology 102(22) 10459-10464.

1. An oxygen reduction electrode that is configured in an electrochemical system comprising a cathode configured as a pleated sheet and an anode comprised of a conductive material.

2. The electrode of claim 1, which additionally includes at least one low pressure air diffuser.

3. The electrode of claim 1, wherein the pleated sheet is comprised of a conductive material.

4. The electrode of claim 3, wherein the conductive material is a metal, a metal compound, a non-metal or a combination thereof.

5. The electrode of claim 4, wherein the metal is titanium, platinum or gold.

6. The electrode of claim 4, wherein the metal compound is a cobalt oxide, a molybdenum oxide, a manganese oxide, a tungsten carbide cobalt, stainless steel or a combination of any metal compounds.

7. The electrode of claim 4, wherein the non-metal is graphite, a graphite-doped ceramic or a conductive polymer.

8. The electrode of claim 1, wherein the sheet is a cloth, felt, foil or mesh.

9. The electrode of claim 8, wherein the foil is a porous or solid metallic foil.

10. The electrode of claim 8, wherein the sheet is a porous or solid graphene sheet.

11. The electrode of claim 8, wherein the mesh is a tightly woven collection of fibers/wires or a mesh of various gap spaces and weave patterns.

12. The electrode of claim 11, wherein the mesh is made of a material selected from the group consisting of titanium, stainless steel or an alloy.

13. An electrode of claim 1, wherein the pleated sheet has been formed on a backing comprised of the same material.

14. An electrode of claim 1, wherein a conductive packing material is within the positive spaces of the pleats.

15. An electrode of claim 1, wherein the conductive packing material is comprised of graphite granules, loose conductive fibers or rolled conductive materials.

16. The electrode of claim 2, wherein the low pressure air diffuser is embedded within the positive space of the pleated sheet, the negative space of the pleated sheet or both.

17. The electrode of claim 1, which is in a tubular configuration.

18. The electrode of claim 1, which is in a flat plate configuration.

19. The electrode of claim 1, wherein the anode is comprised of graphite.

20. The electrode of claim 19, wherein the anode is comprised of graphite coated table tennis balls.
